(19) United States
(12) Patent Application Publication
(10) Pub. No.: US 2003/0035913 A1
(43) Pub. Date: Feb. 20, 2003

(54) Pultrude linear bearing material

(76) Inventor: Benjamin A. Shobert, Carmel, IN (US)

Correspondence Address: Todd T. Taylor, TAYLOR & AUST, P.C., 142 S. Main St., P.O. Box 560, Avilla, IN, 46710, US

(21) Appl. No.: 09/931,714

(22) Filed: Aug. 16, 2001

(51) Int. Cl. B32B 1/08; B32B 5/12; B29C 47/06

(52) U.S. Cl. 428/36.91; 428/113; 264/136; 264/137; 264/171.13; 264/171.26

(57) ABSTRACT

A linear bearing includes a substrate and a strip of wear-resistant material. The strip is impregnated with a resin, and the impregnated strip is pultrusion bonded onto the substrate. The impregnated strip is thereby compressed upon and directly bonded to the substrate.

### BACKGROUND OF THE INVENTION

1. Field of the Invention

The present invention relates to a bearing material, and, more particularly, to a linear bearing material and a method for making such a linear bearing material.

2. Description of the Related Art

Linear bearing materials are typically used in applications involving industrial equipment where a wear pad has insufficient load carrying capacity and either wears excessively or extrudes under high load. Since such wear pads are subject to high compressive loads in both static and dynamic modes. Conventional fill thermoplastics, i.e., Ultra-High Molecular Weight Polyethylene (UHMWPE), Nylatron®, are not acceptable. Additionally, wear pads of this type have previously been simply bonded to the substrate material.

Conventional bearing technology that uses a non-rolling element (i.e., not a conventional roller, ball and needle) as well as metal backed or metallic plane journal bearings employs filled plastic and metals with liquid, powder and/or short fiber lubrication materials. Conventional bearing technology also often presents the need for a secondary lubrication system.

What is needed in the art is a linear bearing material which will not wear excessively or extrude under high load and which will not present the need for a secondary lubrication system.

### SUMMARY OF THE INVENTION

The present invention provides a linear bearing material which includes a strip of resin-impregnated, wear-resistant material that is pultrusion bonded on a substrate, and results in a linear bearing resistant to excessive wear and to extrusion under high load.

The invention comprises, in one form thereof, a linear bearing including a substrate and a strip of wear-resistant material. The strip is impregnated with a resin, and the impregnated strip is pultrusion bonded onto the substrate. The impregnated strip is thereby compressed upon and directly bonded to the substrate.

An advantage of the present invention is that the linear bearing of the present invention is resistant to both excessive wear and extrusion under high load.

Another advantage of the present invention is that the wear-resistant material can be incorporated into the actual structure of the mechanical substrate rather than merely being bonded thereto.

A yet further advantage of the present invention is that the need for a secondary lubrication system is eliminated.

A yet another advantage of the present invention is that the generated friction and cumulative wear is less than that associated with metallic and filled thermoplastic linear bearing materials.

A further advantage of the linear bearing of the present invention is that it can be manufactured in multiple geometric profiles, e.g., flat sheets, rods and tubes, as well as both symmetrical and non-symmetrical profiles.

A yet even further advantage is that the pultrusion provides a load bearing structure that is capable of very high static and dynamic loading and can handle permanent set conditions better than metal extrusions or thermoplastic extruded materials.

A further advantage of the present invention is that the pultrusion provides a strength member with better strength to weight advantages than conventional materials.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a partial cutaway view of a linear bearing of the present invention;

FIG. 2 is a schematic view of the system used to produce the linear bearings of the present invention;

FIG. 3 is a perspective view of another embodiment of a linear bearing of the present invention;

FIG. 4 is a perspective view of yet another embodiment of the present invention; and

FIG. 5 is a schematic view of yet a further embodiment of the linear bearing of the present invention.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF THE INVENTION

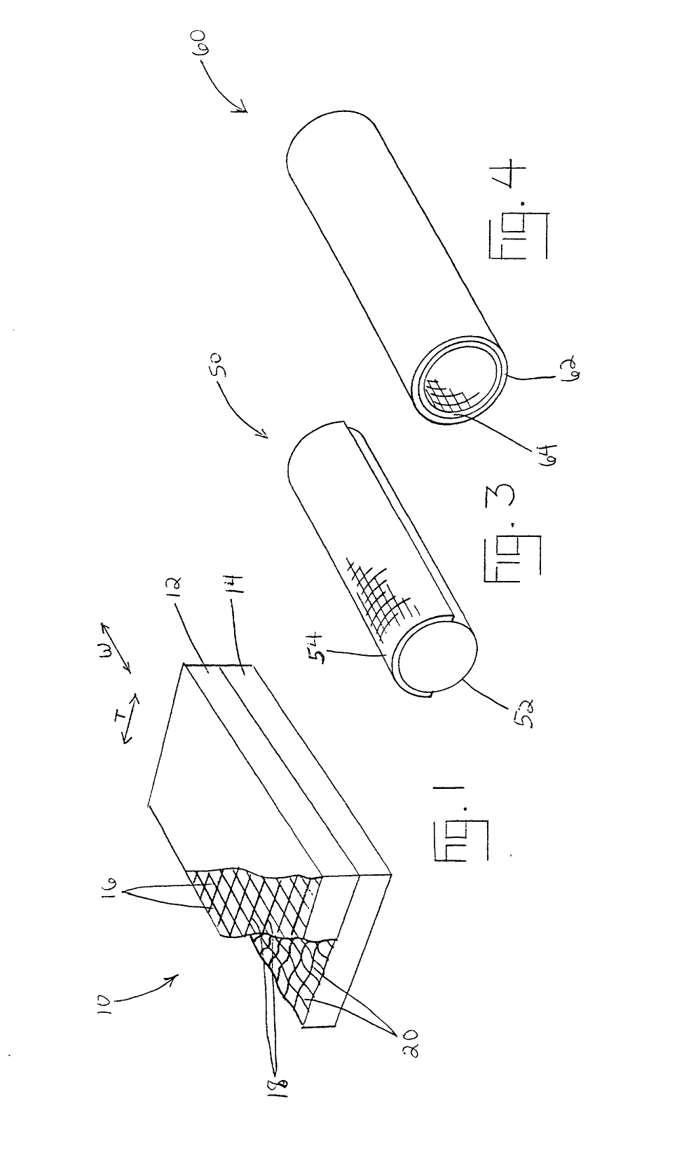

Referring now to the drawings, and more particularly to FIG. 1, there is shown a linear bearing 10 which generally includes a wear-resistant layer 12 and a substrate 14, wear-resistant layer 12 being pultrusion bonded upon substrate 14.

Wear-resistant layer 12 is constructed of anti-friction fibers 16 which are oriented in a wear axis direction W of linear bearing 10 and is commingled with second fibers 18. Anti-friction fibers 16 are preferably made of a self-lubricating material. One such self-lubricating material is polytetrafluoroethylene, otherwise known as PTFE. Using a self-lubricating material is advantageous in that it is capable of generating a non-hydrodynamic layer of lubrication through a film transfer process (the process by which PTFE from the bearing wear surface fills in the surface voids of a mating wear surface).

Second fibers 18 do not serve anti-friction purposes but serve as a mechanical lock in a transverse direction T of anti-friction fibers 16. This mechanical locking helps overcome the fact that anti-friction fibers 16 typically bond very poorly to most substrate materials with most commonly usable resin matrices. Anti-friction fibers 16 and second fibers 18, with anti-friction fibers 16 oriented in wear axis direction W and second fibers 18 in locking or transverse direction T, are constructed in what is roughly an off-axis orientation (one fiber set going in the 0° array and the second set going in the 90° array). Together anti-friction fibers 16 and second fibers 18 construct a fabric that can be introduced into linear bearing 10.

Substrate 14 is preferably made of a continuous fiber thermoset with reinforcing fibers 20. A preferred backing material for substrate 14 is fiberglass.

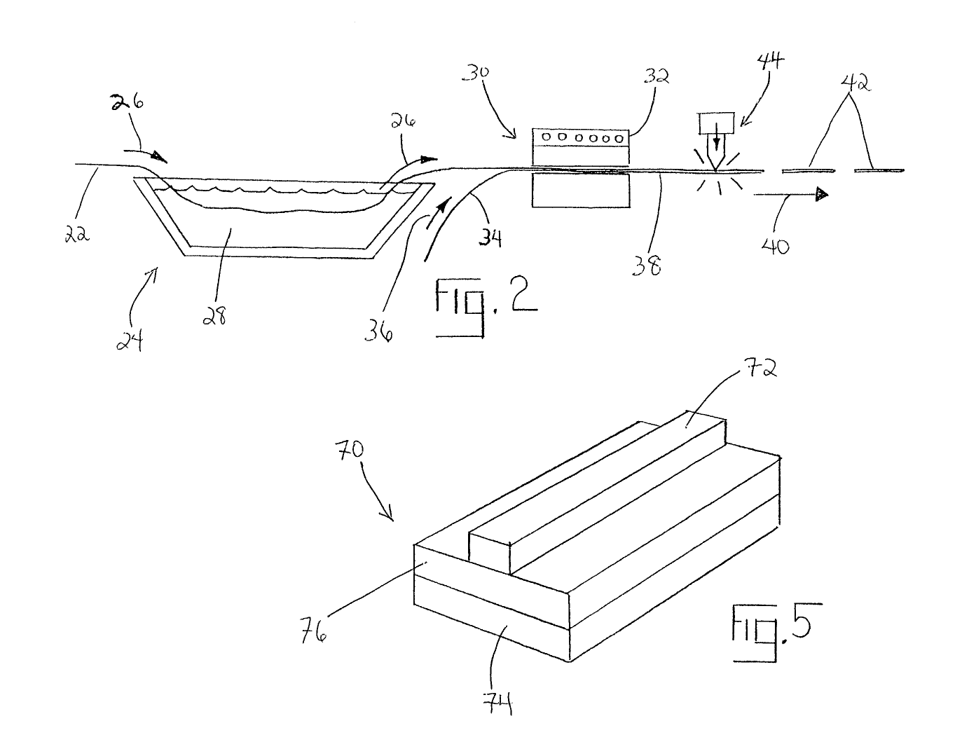

A process of making linear bearing 10 is shown in FIG. 2. Wear fabric material 22, composed of anti-friction fibers 16 and second fibers 18, is transported into and out of resin bath 24 by conveyor system 26 (shown schematically with arrows). While being transported through resin bath 24, wear fabric material 22 becomes throughly impregnated with resin 28. Conveyer system 26 then conveys impregnated wear fabric material 22 toward and into pultrusion die 30, which is heated by heater 32. Simultaneously, fibrous substrate 34 is moved toward and into pultrusion die 30 by second conveyor 36 (shown schematically with an arrow). Conveying systems 26 and 36 coact in such a manner so as to gradually orient impregnated wear fabric material 22 and fibrous substrate 34 into the alignment ultimately desired by the time pultrusion begins. Pultrusion die 30 pulls impregnated wear fabric material 22 and fibrous substrate 34 thereinto where resin 28 is catalyzed and finally cured during pultrusion, impregnated wear fabric material 22 is compressed upon and directly bonded to fibrous substrate 34, thereby forming a composite linear bearing material 38. As such, impregnated wear fabric material 22 may be considered to be a preset layer of composite linear bearing material 38.

Upon exiting from pultrusion die 30, the profile of composite linear bearing material 38 is locked into its final geometric tolerances and general shape. At this point, composite linear bearing material 38 is pulled by a third conveyor 40 (schematically shown as an arrow) and cut to length into linear bearings 42 by cutter mechanism 44.

FIGS. 3-5 show various embodiments of the linear bearing of the present invention. As seen from these figures, wear-resistant layer 12 can be situated along any axial direction of a given linear bearing and is unlimited in it use in profile geometries. Specifically, linear bearing 50 is comprised of a substrate rod 52 upon which wear-resistant layer 54 has been pultruded thereonto, wear-resistant layer 54 being located on the upper half of substrate rod 52. In FIG. 4, linear bearing 60 is composed of a substrate tube 62 having a wear-resistant layer 64 formed therein. Finally, linear bearing 70 (FIG. 5) has first and second wear-resistant layers 72 and 74 formed on opposite sides of flat substrate 76. In this embodiment, first wear-resistant layer 72 is non-coextensive with flat substrate 76, while second wear-resistant layer 74 is coextensive therewith. As can be seen from FIGS. 1 and 3-5, the wear-resistant fabric can be introduced into a specific section of the substrate that will be subjected to the primary motion and hence where the wear issue presents itself at.

One example (not shown) of where a linear bearing of the present invention could be used is on a window lineal upon whose surface the upper sash of the window would raise and lower upon. In such an instance, the direction of raising and lower of the window would establish the primary wear axis, along which the self-lubricating material of the linear bearing of the present invention could readily be aligned with.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A linear bearing, comprising:
a substrate; and
a strip of wear-resistant material, said strip being impregnated with a resin, said impregnated strip pultrusion bonded onto said substrate, said impregnated strip thereby being compressed upon and directly contacting and bonded to said substrate.

2. The linear bearing of claim 1, wherein said substrate is a structural, load-bearing, continuous fiber substrate.

3. The linear bearing of claim 2, wherein said substrate is comprised of fiberglass.

4. The linear bearing of claim 1, wherein said substrate has a shape, said shape being one of a flat sheet, a tube, and a rod.

5. The linear bearing of claim 1, wherein said wear-resistant material includes a plurality of first fibers, said first fibers being comprised of a self-lubricating material.

6. The linear bearing of claim 5, wherein said self-lubricating material is polytetrafluoroethylene.

7. The linear bearing of claim 5, wherein said linear bearing has a wear axis, said first fibers being oriented substantially longitudinally along said wear axis.

8. The linear bearing of claim 5, wherein said first fibers are commingled with a plurality of second fibers, said second fibers being oriented relative to said first fibers in a direction one of transverse and off-axis thereto, said second fibers mechanically locking said first fibers in place.

9. The linear bearing of claim 1, wherein said resin is a thermosetting resin, said resin thermosetting during said pultrusion bonding.

10. The linear bearing of claim 1, wherein said substrate is at least as large as said strip.

11. A method of making a linear bearing, comprising the steps of:
providing a substrate and a strip of wear-resistant material;
impregnating said strip with a resin;
pultruding said impregnated strip and said substrate together through a die, said pultruding thereby compressing said impregnated strip upon said substrate and directly bonding said impregnated strip thereto, said impregnated strip thereby directly contacting said substrate.

12. The method of claim 11, wherein said substrate is a structural, load-bearing, continuous fiber substrate.

13. The method of claim 12, wherein said substrate is comprised of fiberglass.

14. The method of claim 11, wherein said substrate has a shape, said shape being one of a flat sheet, a tube, and a rod.

15. The method of claim 11, wherein said wear-resistant material includes a plurality of first fibers, said first fibers being comprised of a self-lubricating material.

16. The method of claim 15, wherein said self-lubricating material is polytetrafluoroethylene.

17. The method of claim 15, wherein said linear bearing has a wear axis, said method further comprising the steps of orienting said first fibers in a substantially longitudinal alignment along said wear axis prior to bonding said strip upon said substrate and maintaining said alignment during said bonding.

18. The method of claim 15, wherein said first fibers are commingled with a plurality of second fibers, said second fibers being oriented relative to said first fibers in a direction one of transverse and off-axis thereto, said second fibers mechanically locking said first fibers in place.

19. The method of claim 11, wherein said resin is a thermosetting resin, said resin thermosetting during said step of pultruding.

20. The method of claim 11, wherein said step of impregnating includes a substep of introducing said strip into a bath of said resin.

21. The method of claim 11, wherein said impregnated strip is preset upon said substrate during said step of pultruding.
